(19) United States
(12) Patent Application Publication
(10) Pub. No.: US 2010/0140831 A1
(43) Pub. Date: Jun. 10, 2010

(54) Molded object-forming apparatus and method

(75) Inventor: Carl Ondracek, Plano, TX (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Computerized Cutters, Inc.

(21) Appl. No.: 12/314,220

(22) Filed: Dec. 5, 2008

(51) Int. Cl. B28B 7/14

(52) U.S. Cl. 264/163; 425/112

(57) ABSTRACT

An apparatus and method for forming a molded object, e.g., a channel letter trim and trimmed face. A shape is stored in a processor. A mold material is held by vacuum on a table, movably supported on a support frame. The table moves to a second position on the support frame, where the mold material is cut into a mold having the stored shape. The table and mold are moved to a third position on the support frame. Heated synthetic material is drawn over the mold by vacuum. After the synthetic material hardens, excess material is cut off, if necessary, and the synthetic material, now in the shape of the mold, is removed from the mold.

### FIELD OF THE INVENTION

The present invention relates to a molded object-forming apparatus, and a method of forming a molded object. In particular, the molded object-forming apparatus, and the method relate to forming a molded synthetic trim cap for a channel letter.

### DESCRIPTION OF THE RELATED ART

Three dimensional channel letters are well-known in the sign industry. A channel letter includes a three-dimensional letter or numeral-shaped “can,” typically made of thin sheet metal, closed at an end which faces the sign or wall, and open at another end which faces outward, with lights supported inside the “can,” and a transparent synthetic face or cap attached to the open end. The face or cap has the same letter or numeral shape as the can, with a flange for attaching the edges of the trim cap to the open end of the can. When the sign is turned on at night, light shines through the transparent faces or caps of the respective channel letters so the sign can be seen.

Traditionally, faces have been cut by hand or computer controlled cutting machines, with an outer plastic edge trim pressed tight against the cut out face and then glued together thus forming the trimmed face. This process is time-consuming and expensive. The trimmed face is then attached to the channel letter.

It is desirable to provide an apparatus and method to form a synthetic trimmed face with an automatic machine, with all steps performed on a single machine at a single location.

It is further desirable that the trimmed face forming machine and method be suitable for forming other molded objects.

### SUMMARY OF THE INVENTION

As broadly embodied herein, a molded object forming-apparatus includes a processor storing a shape of an object, preferably a letter or a numeral. A support frame is provided, upon which all of the components of the apparatus are mounted. A table moves on the support frame between a plurality of positions. A first vacuum device holds a mold material, e.g., plywood or MDF, at a first table position on the support frame. A cutting apparatus is positioned above the support frame, table, and mold materials at a second table position. A first moving apparatus moves the table to the second table position. At the second table position, hydraulic alignment pins engage and secure the table into a cutting position, a lifting device latches onto the mold material, and lifts it upward off of the table toward the cutting apparatus, and the alignment pins disengage from the table. As the mold material moves toward the cutting apparatus, the table returns to the first table position on the support frame. The cutting apparatus performs a first cutting operation on the mold material. The first cutting operation can be performed in a raised or a lowered position. In cases where the mold material is being formed for a channel letter trimmed face, having a letter shape, the first cutting operation cuts out an inner portion of the respective letter, e.g., the inner portion of a letter “A,” or a letter “R.” Scrap material cut off the mold in this first cutting operation drops downward into a trash bin below the support frame. This is possible because the table earlier moved back to the first table position.

The first moving apparatus returns the table to the second table position beneath the cutting apparatus, the alignment pins engage and secure the table into the cutting position, and the lifting device lowers the mold material back down onto the table, but the lifting device nevertheless continues holding the mold material. The first vacuum device turns back on and holds the mold material onto the table. A cutter in the cutting apparatus descends to the level of the mold material, and performs a second cutting operation on the mold material, e.g., cutting out the rest of the letter “A” or “R.”

After cutting the outside of each letter or shape, the first vacuum device turns off, and the lifting device lifts upward off of the table with only the uncut scrap material. The first vacuum device turns back on, holding the cutout material, the alignment pins disengage from the table, and the first moving apparatus moves the table with the cutout mold material to the first table position. The lifting device then releases the scrap molding material into the trash bin.

The first moving apparatus then moves the table back to the second table position. The alignment device engages and secures the table into an exact second position. The table waits at the second table position until the synthetic material reaches a desired state of softness.

At the third table position a sheet of synthetic material is held by a synthetic material holding device above the support frame, and heated by a heating device.

When the synthetic material reaches a desired state of softness, the first, or a second moving apparatus moves the table to a third position, and alignment pins engage and secure the table into a plastic molding position. The synthetic material is lowered down onto the mold, and drawn downward by a second vacuum device. The synthetic material acquires the shape of the mold, with downwardly extending side portions extending into horizontally-extending side portions.

The alignment pins disengage from the table, and the first or a second moving apparatus moves the table with the molded material to the second table position. The alignment pins engage and secure the table into the cutting position where the cutting apparatus cuts the undesirable excess synthetic portions off of the molded object.

The alignment pins disengage from the table, and the first moving apparatus moves the table with the molded and trimmed part to the first table position, and the molded trimmed face or object is removed from the support frame.

Preferably, each of the first and second moving apparatuses include a pair of parallel elongated rails, a sliding device having a rail gripping surface, and a support surface for supporting the table, and a transfer device for transferring the sliding device and the table from one elongated rail to the other elongated rail.

Additional features and advantages of the invention will be set forth in the description which follows, and in part will be apparent from the description, or may be learned by practice of the invention. The advantages of the invention will be realized and attained by the apparatus and method particularly described in the written description, depicted in the drawings, and recited in the claims of this application.

### BRIEF DESCRIPTION OF THE DRAWINGS

The accompanying drawings are included to provide a further understanding of the invention, are incorporated in and constitute a part of this specification, illustrate a preferred embodiment of the invention, and together with the description serve to explain the principles of the invention.

FIG. 1 is a detailed perspective view of a molded-object forming apparatus in accordance with the presenting invention;

FIG. 2 is a partial perspective view of a support frame used in the apparatus of FIG. 1;

FIG. 3 is a side view of a table, used in a molded-object forming apparatus, in accordance with the present invention, depicting a first table position on the support frame;

FIG. 4 is a side view, similar to FIG. 2, but with the table moved to a second table position on the support frame;

FIG. 5 is a side view similar to FIG. 4, depicting a lifter in a lowered unclamped position on a mold material on the table, while the table is in the second table position on the support frame;

FIG. 6 is a side view similar to FIG. 5, but with the lifter in a clamped position, engaging the mold material on the table;

FIG. 6 is a side view depicting the lifter lifting the mold material off of the table and toward a cutting apparatus;

FIG. 7A is a top view and 7B is a side view depicting the cutting apparatus performing a first cutting operation on the mold material;

FIG. 8A is a top view and 8B is a side view depicting the cutting apparatus performing a second cutting operation on the mold material;

FIG. 9A is a top view and 9B is a side view depicting the scrap material falling into a trash bin after the first cutting operation, while the table is in the first table position;

FIGS. 10A and 10B are side views depicting a heater in the third table position heating a synthetic material and the synthetic material beginning to deflect after heating;

FIGS. 11A-C are side views depicting the synthetic material being lowered onto the mold and acquiring the shape of the mold;

FIGS. 12A-E are side views depicting the positioning and mechanics of the first and second moving apparatus;

FIG. 13 is a detailed drawing depicting an embodiment of the alignment pins;

FIGS. 14A-C are partial perspective views depicting an embodiment of the invention with a single set of elongated rails.

FIGS. 15A-D are drawings showing the cutting apparatus in both raised and lowered positions.

### DETAILED DESCRIPTION OF THE PREFERRED EMBODIMENTS

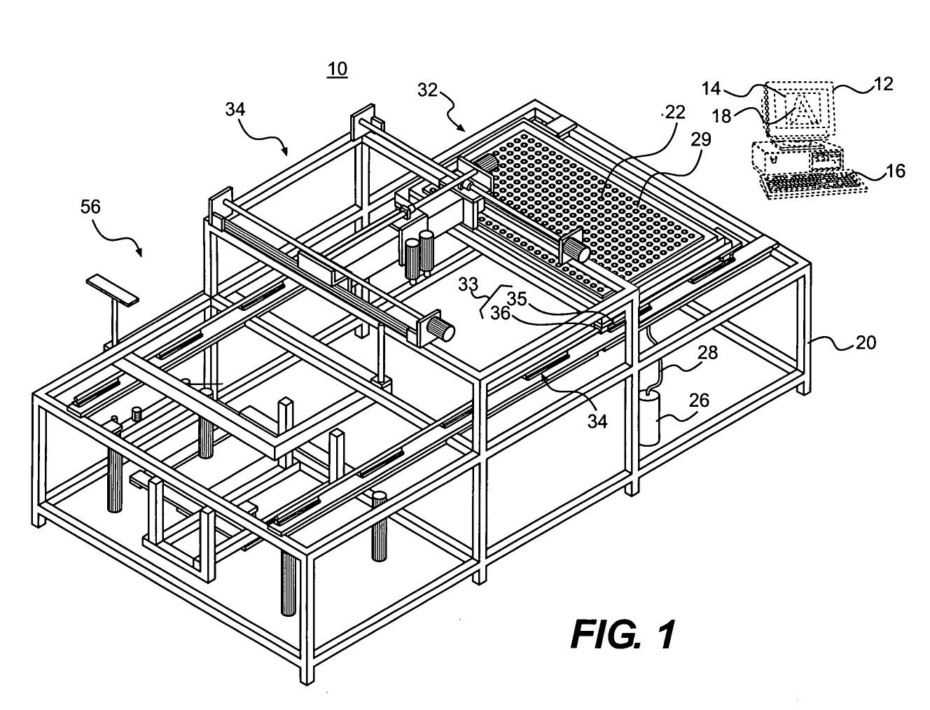

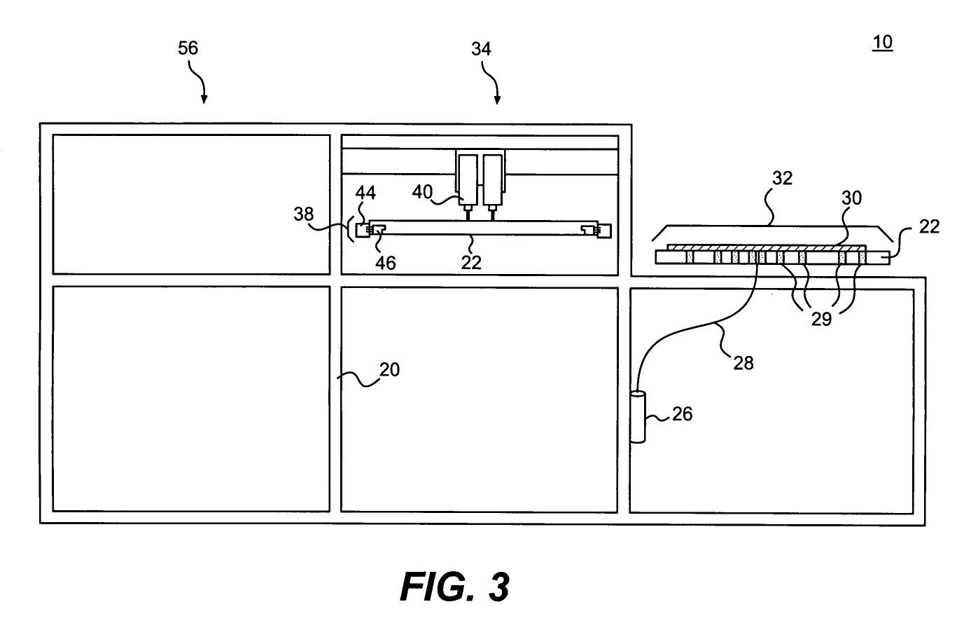

In accordance with the invention, and as broadly embodied in FIGS. 1-3, a molded-object forming apparatus 10 includes a processor 12 storing a shape of an object. Preferably, the processor 12 is a well-known commonly available desk-top computer, including a CPU (not shown), a memory, an LCD screen 14, and a keyboard 16, for inputting into the memory a shape of an object 18, e.g., a letter “A.”

As broadly embodied herein, the apparatus 10 further includes a support frame 20, supporting a transfer table or table 22, movable between a plurality of table positions.

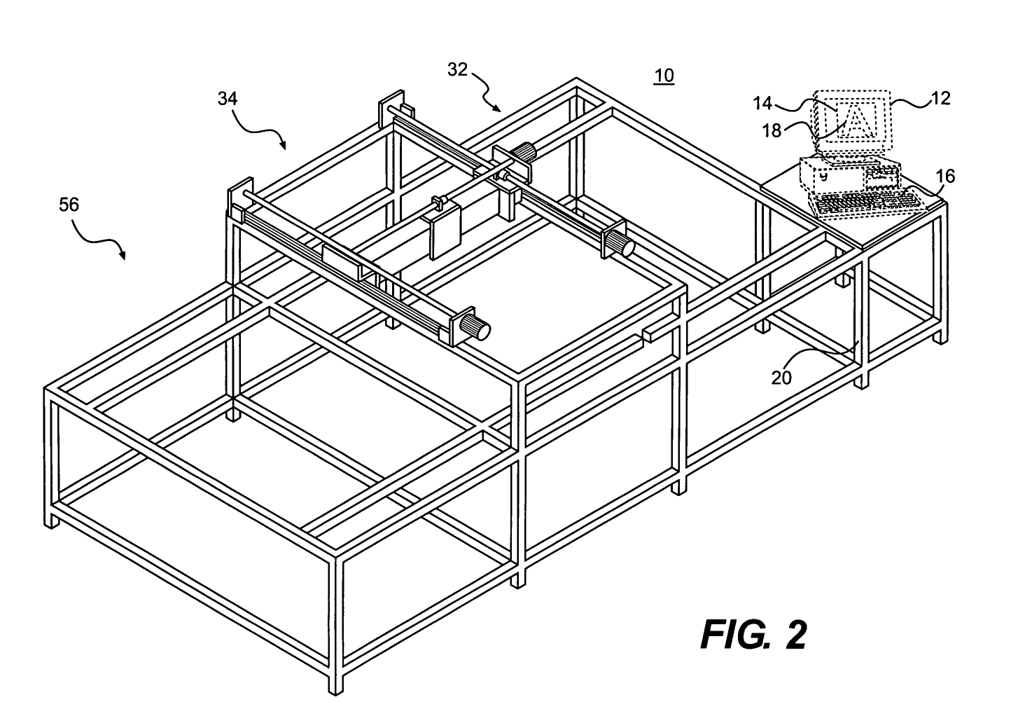

In accordance with the invention, and as broadly embodied in FIGS. 1 and 2, the processor 12 can be supported on the support frame 20, or at a provided remote location.

In accordance with the invention, a plurality of hydraulic pins is provided at each table position. A first set of hydraulic transfer pins 24 are provided at a first table position 32. When fired into corresponding apertures on table 22, the transfer pins 24 allow the table 22 to move along a first moving apparatus 33 between the first table position 32 and a second table position 34. The first set of transfer pins 24 can then retract, and a second set of transfer pins 24 are provided at the second table position 34. When fired into the corresponding apertures on the table 22, the second set of transfer pins 24 allow the table 22 to move between the second table position 34 and a third table position 56. In another embodiment, the hydraulic transfer pins may not be necessary, and another means may be used to transfer the table to the second table position 34 or to the third table position 56.

In accordance with the invention, alignment pins are provided at the second table position 34 and the third table position 56 in order to properly position the table 22 in the second table position 34 or the third table position 56, respectively. In another embodiment, the alignment pins may not be necessary, and another means may be used to align the table.

In accordance with the invention, a first vacuum device 26, preferably a vacuum suction pump, leads via a manifold 28 to a plurality of suction openings 29 in the table 22. Vacuum drawn via the suction openings 29 allows a molding material 30 to be drawn into contact with, and be held by, table 22. Preferably, mold material 30 is made of plywood or MDF®, which are well known in the art.

As broadly embodied herein, the mold material 30 is secured to the table 22 at the first table position 32.

A first moving apparatus 33 is provided for moving the table 22 and the mold material 30 from the first table position 32 to the second table position 34. As broadly embodied herein, first moving apparatus 33 preferably includes a first pair of elongated rails 35, with one rail positioned on either side of the table 22, and a block 36, configured to support the table 22, and movable along the rails 35 between the first table position 32 and the second table position 34.

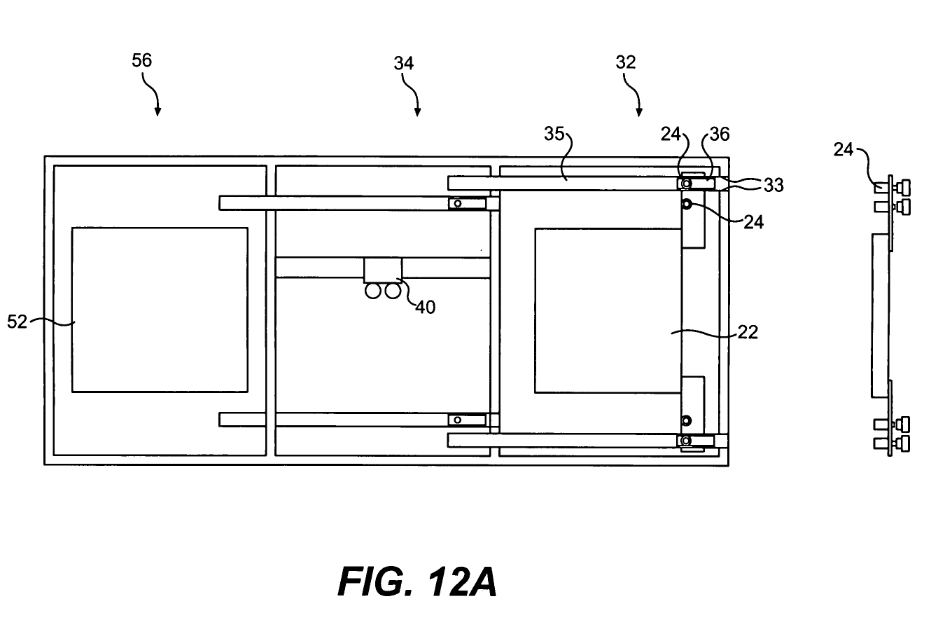

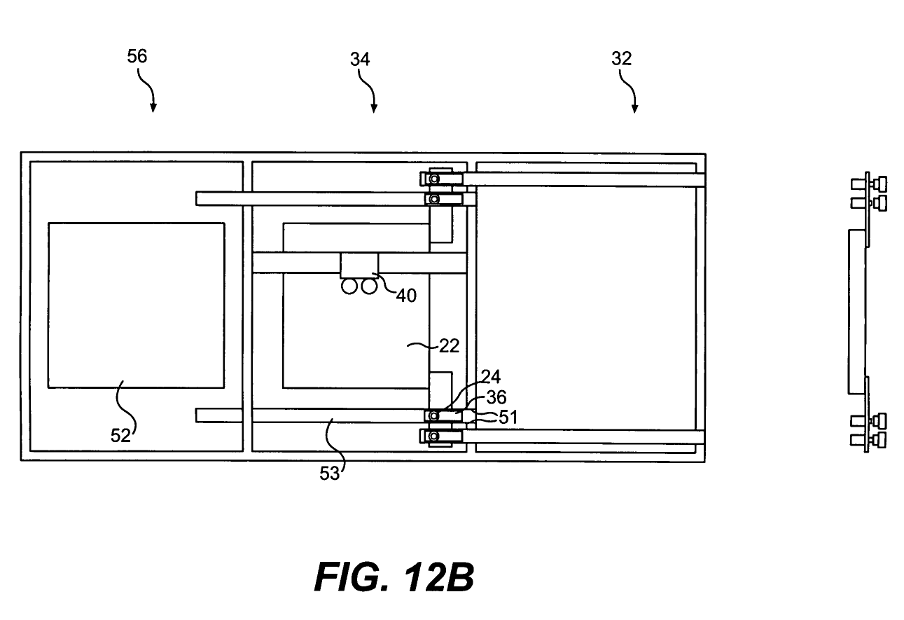

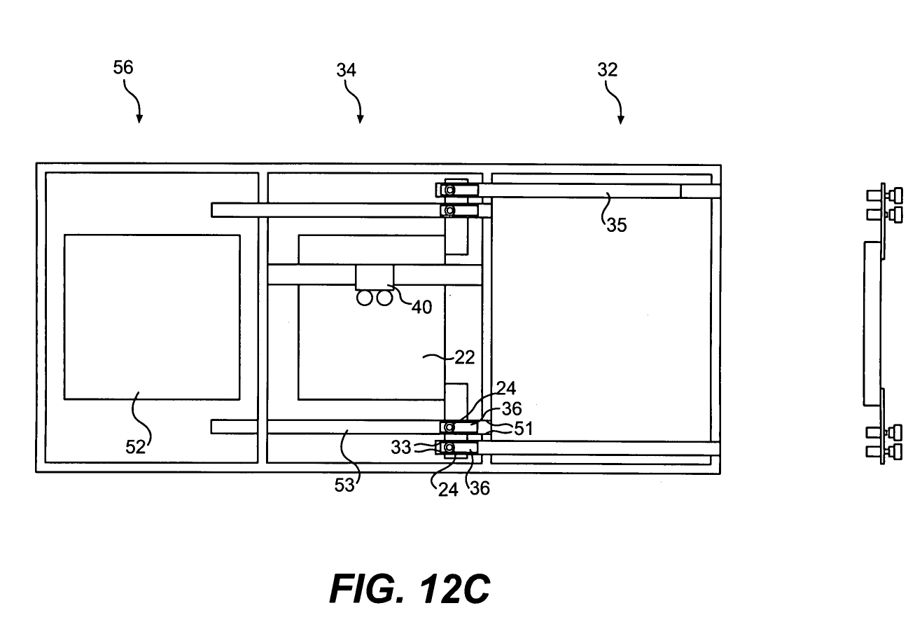

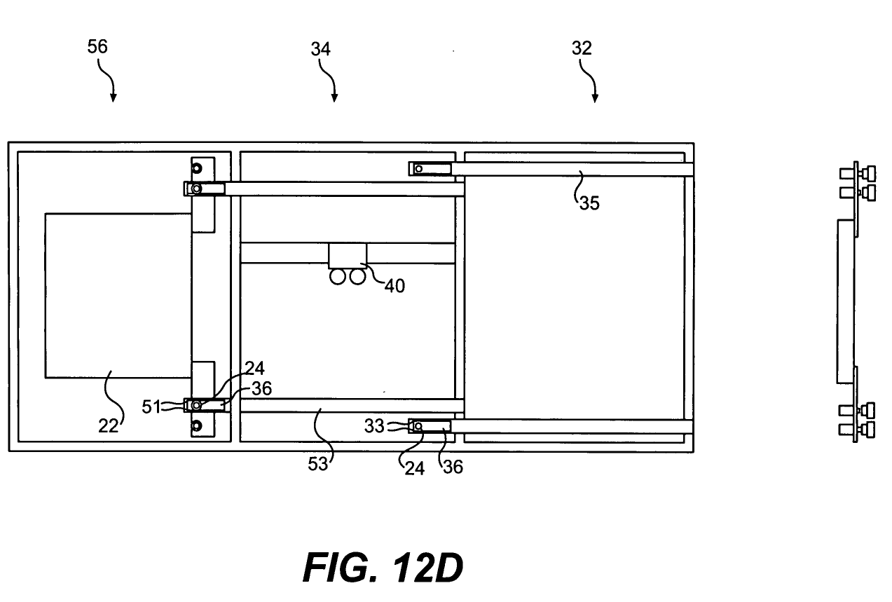

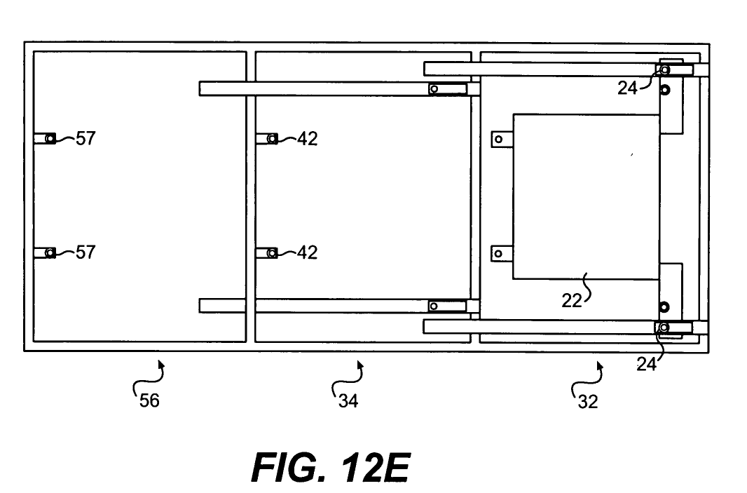

In accordance with the invention, a lifter 38 is provided at the second table position 34, configured to attach to the mold material 30, and lift it up off of the table 22, into proximity with a cutting apparatus 40. As broadly embodied herein, and described in detail below with respect to FIG. 12E, when table 22 reaches the second table position 34 a set of hydraulic alignment pins 42 are provided to fire and align table 22 in position for the lifter 38 to be lowered onto and engage the mold material 30, as described below.

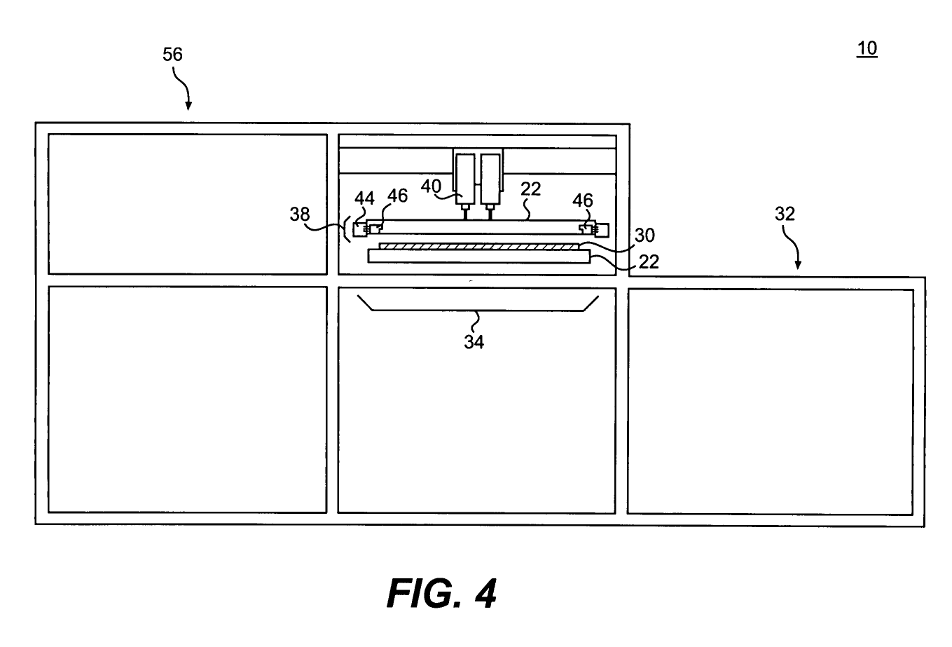

Preferably, referring to FIG. 4, lifter 38 includes a clamping frame 44 and clamps 46.

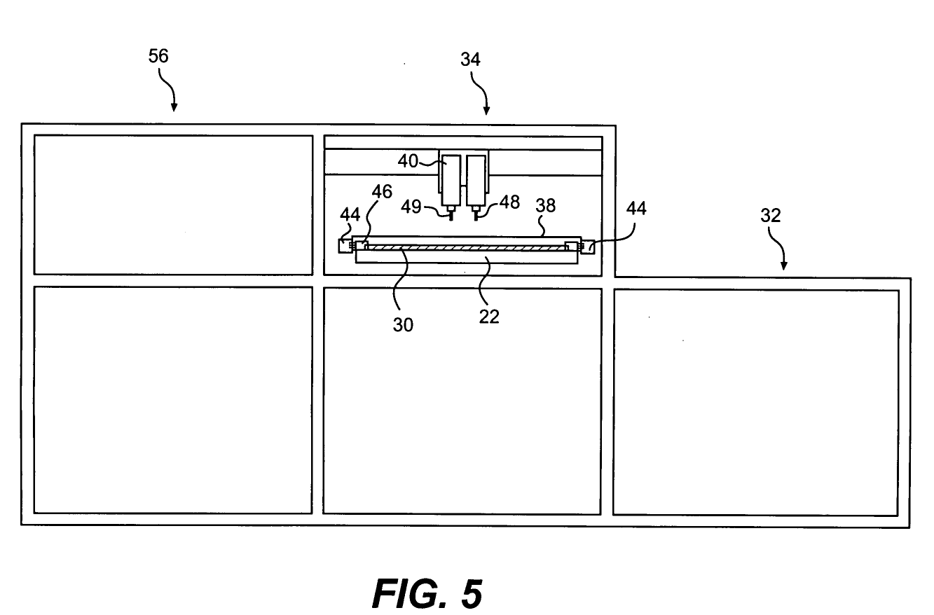

As broadly embodied in FIG. 5, the clamps 46 are provided to engage the mold material 30. In accordance with the invention, the cutting apparatus 40 includes a first cutter 48 and a second cutter 49. In another embodiment, a single cutter could be used.

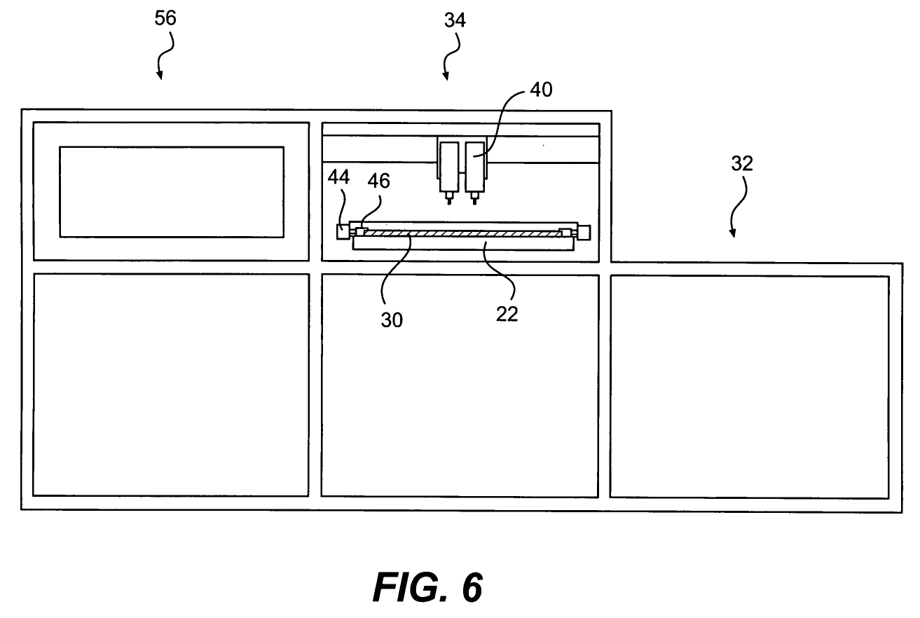

Referring to FIG. 6, the clamping frame 44, after engaging mold material 30, lifts mold material 30 up above and out of contact with table 22 in the direction of the cutting apparatus 40. Preferably, the first vacuum device 26 turns off before the mold material 30 is lifted off the table 22.

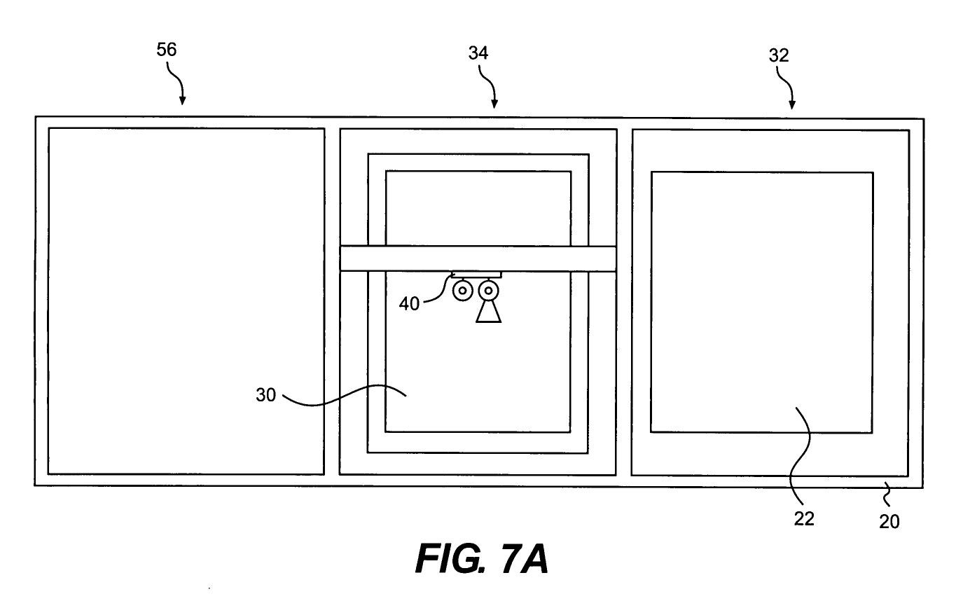

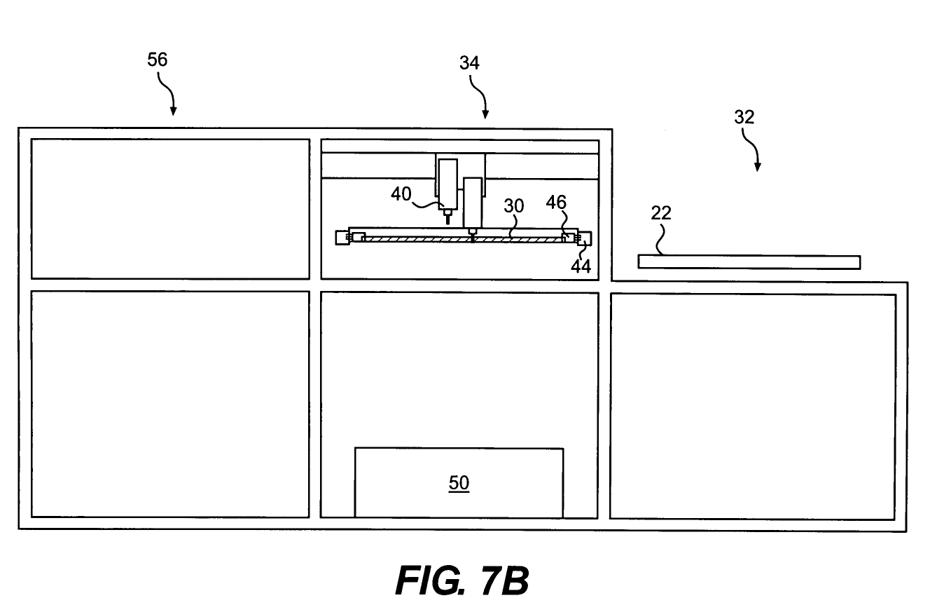

In accordance with the invention, and as broadly depicted in FIGS. 7A and 7B, when the mold material 30 is lifted by the clamping frame 44 into the vicinity of the cutting apparatus 40, table 22 is configured to move on the rails 35 back to the first table position 32.

In accordance with the invention, the cutting apparatus 40 is provided to perform a first cutting operation on the mold material 30, such as cutting an inside portion of the mold material 30. A trash bin 50 is provided to receive scrap material cut off the mold material 30 during the first cutting operation.

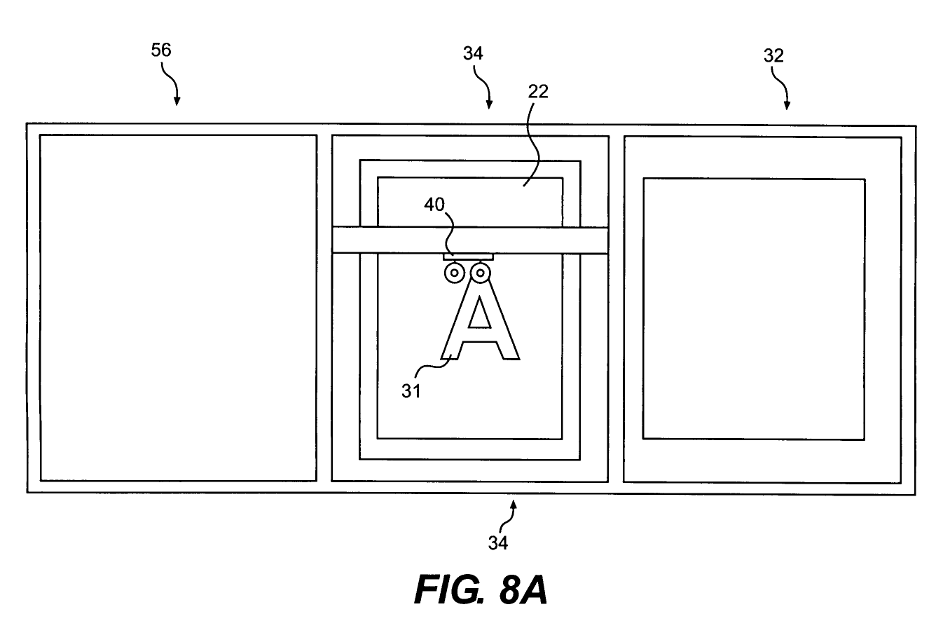

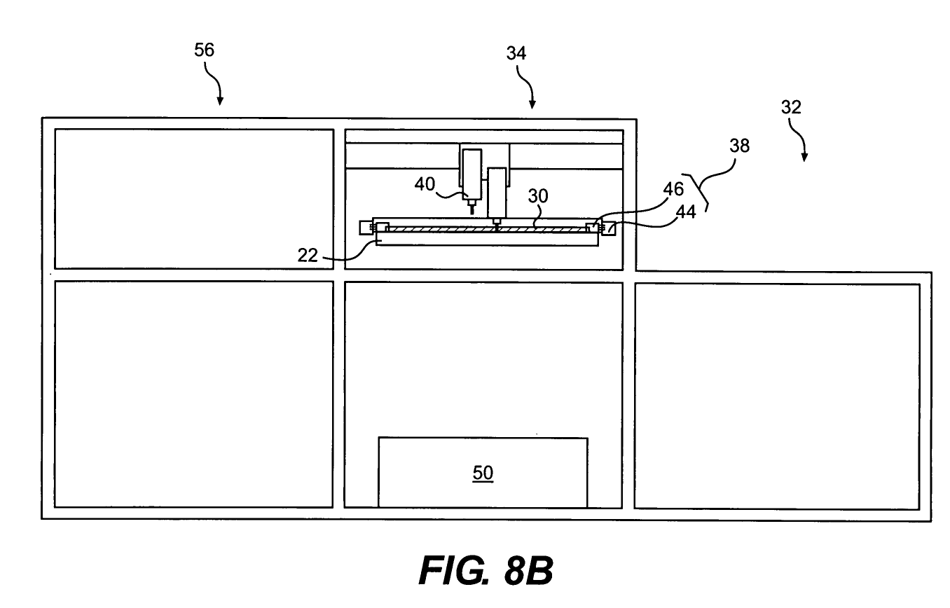

In accordance with the invention, and as broadly depicted in FIGS. 8A and 8B, table 22 is configured to move on the rails 35 back into the second table position 34. Lifter 38 is configured to lower the mold material 30 onto the table 22.

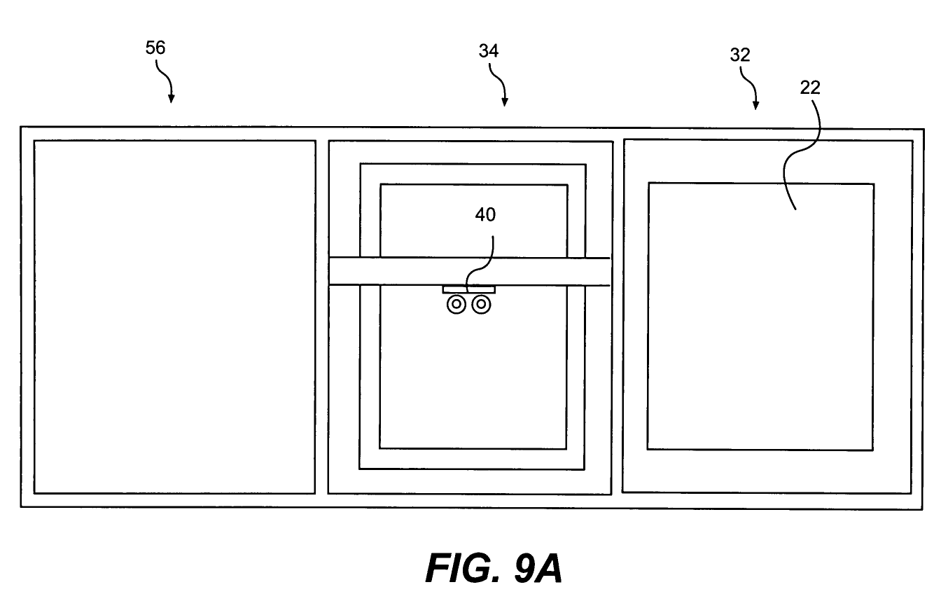

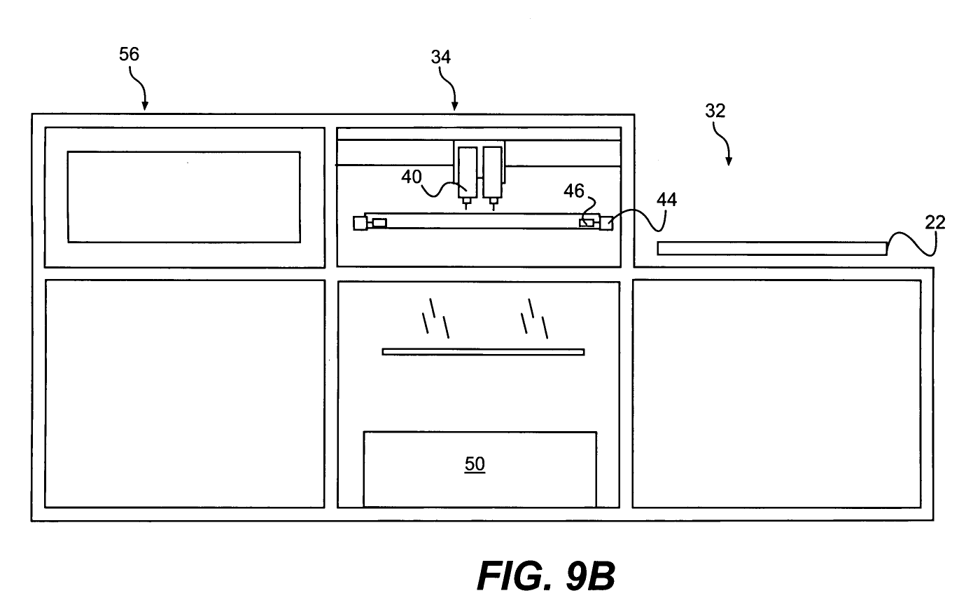

Referring to FIGS. 9A and 9B, the table 22 is configured to move on the rails 35 again to the first table position 32. The trash bin 50 is provided to receive scrap material cut off the mold material 30 during the second cutting operation. After at least the first and/or second cutting operations, the mold material 30 has the desired shape of the object 18, thereby defining the desired mold 31.

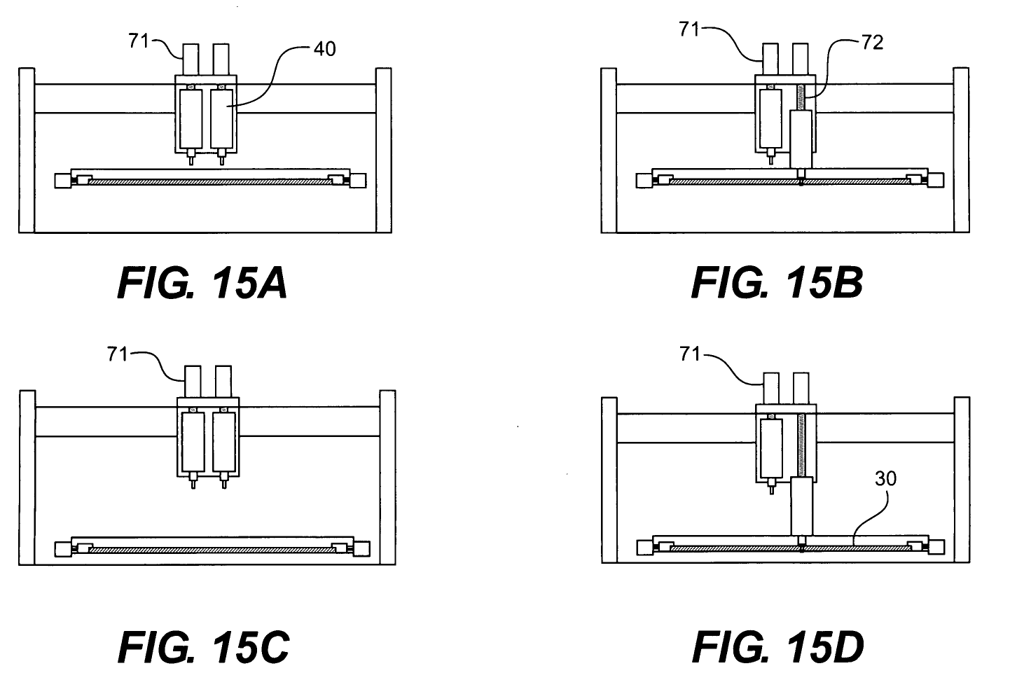

The cutting apparatus 40 is configured to lower to the level of the table 22 and perform a second cutting operation on the mold material 30, such as cutting an outside portion of the mold material 30. The movement of the cutting apparatus is described below with respect to FIGS. 15A-D.

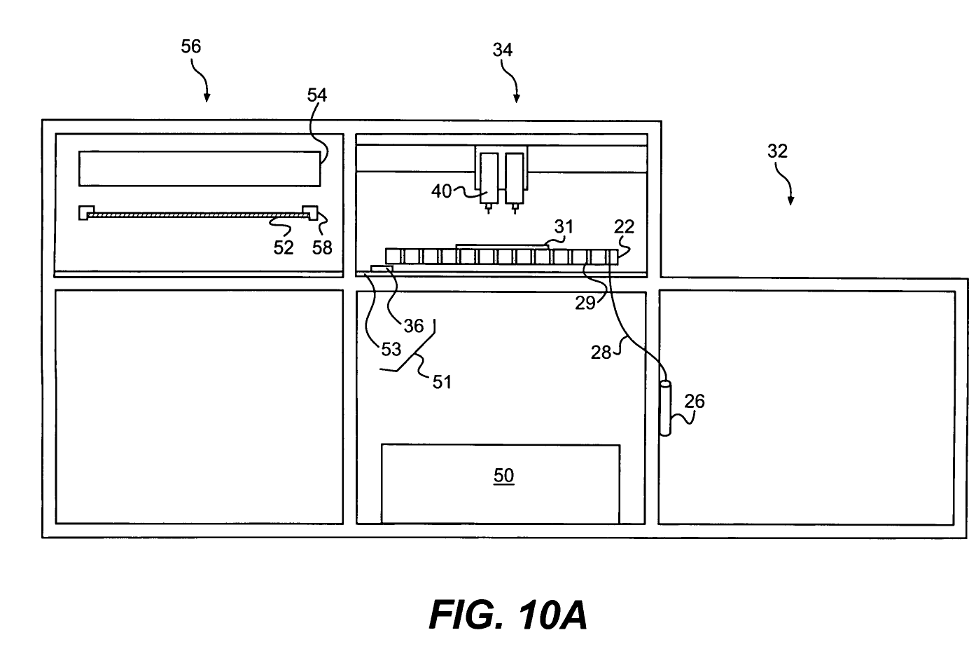

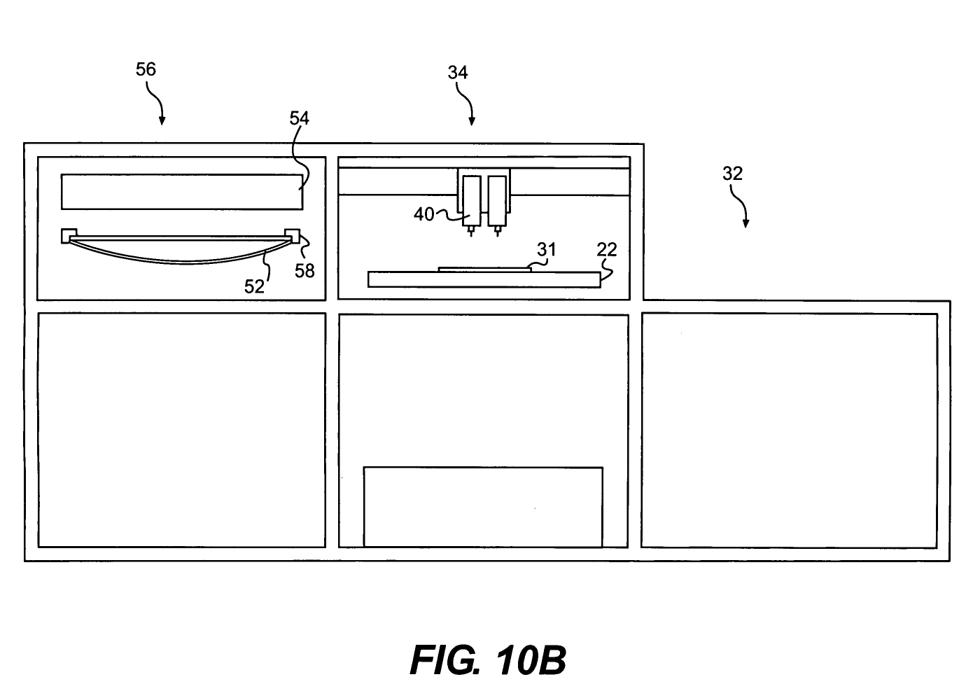

In accordance with the invention, and as broadly depicted in FIG. 10A, the table 22 is configured to move back into the second table position 34. The first vacuum device 26 is provided to lead via the manifold 28 to the plurality of suction openings 29 in the table 22. Vacuum drawn via the suction openings 29 allows the mold 30 to be drawn again into contact with, and held be by, the table 22.

A second moving apparatus 51 is provided for moving the table 22 and the mold material 30 from the second table position 34 to the third position 56. As broadly embodied herein, second moving apparatus 51 includes a second pair of elongated rails 53, with one rail positioned on either side of the table 22, and a block 36, configured to support the table 22, and movable along the rails 53 between the second table position 34 and the third table position 56.

In another possible embodiment, as described below, a single pair of elongated rails is provided to move from the first table position 32 to the second table position 34 or directly to the third table position 56, and vice versa.

As broadly depicted in FIGS. 10A and 10B, at the third table position 56, a synthetic material 52 is held by a synthetic material holding device 58, and a heated device 54 is provided to heat the synthetic material 52.

In accordance with the invention, and as broadly illustrated and described below with respect to FIG. 12, a third set of hydraulic positioning pins 57 are provided at the third table position 56. When fired into corresponding apertures on table 22, the third set of position pins 57 position the table 22 in the position to receive the plastic molding at the third table position 57 to receive the synthetic material 52.

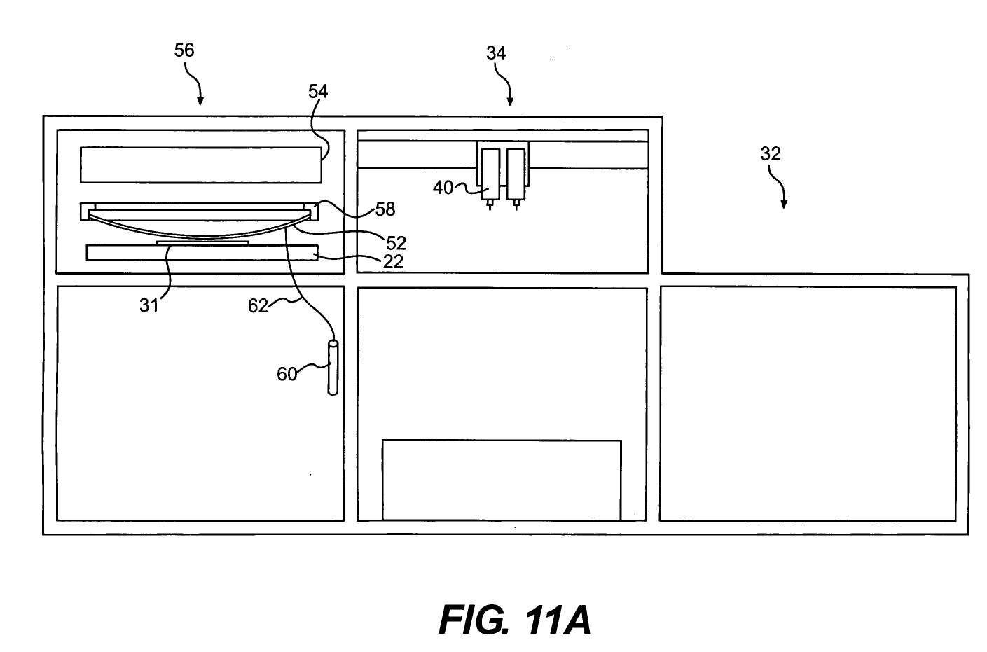

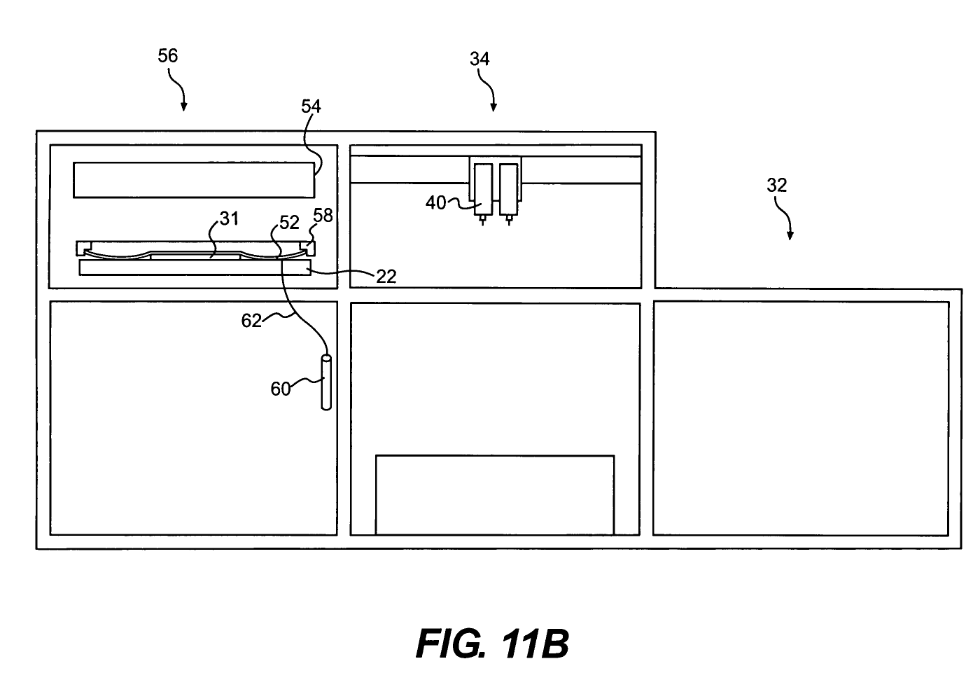

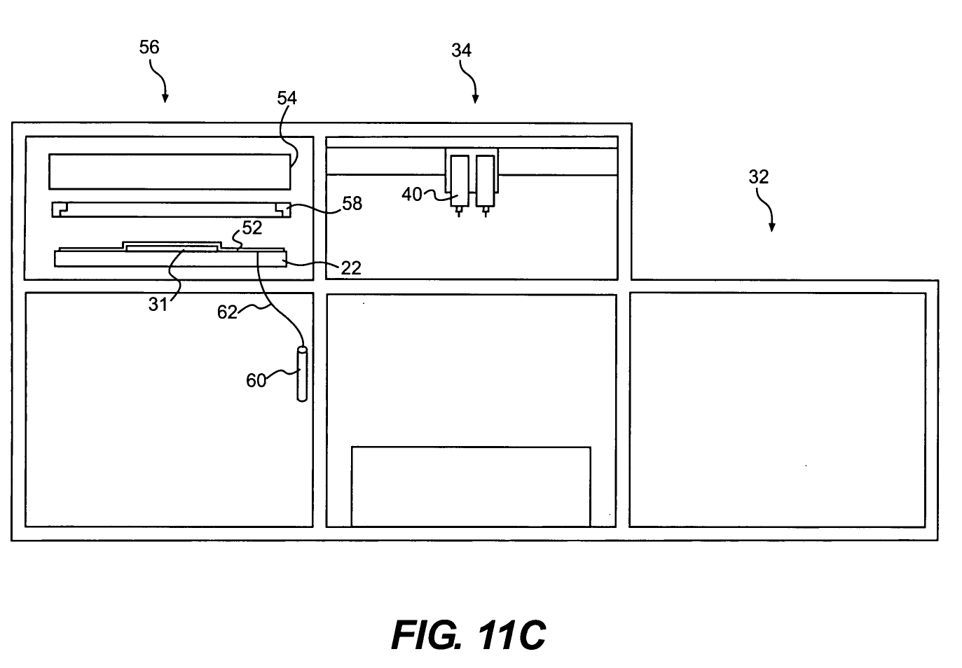

In accordance with the invention, and as broadly depicted in FIGS. 11A-C, a second vacuum device 60 is provided to draw the synthetic material 52 via a second manifold 62 to the mold 30 on the table 22. Vacuum drawn via the suction allows the synthetic material 52 to acquire the shape of the mold 30. It should be understood that the invention may encompass a single vacuum device for all vacuum operations, or it may encompass multiple vacuum devices.

In accordance with the invention, the table 22 is configured to move on the rails 35 back into the second table position 34. The cutting apparatus 40 is provided to lower to the level of the table 22. The cutting apparatus 40 is provided to perform a third cutting operation, if necessary, such as cutting an excess of synthetic material 52 that did not acquire the shape of the mold 31.

In accordance with the invention, the table 22 is configured to move on the rails 35 back into the first table position 32, where the synthetic material 52, now in the shape of the mold 31, can be removed from the table 22.

In accordance with the invention, the mold 30, having been cut to the desired shape of the object 18 may be re-used. In the case of re-use, the mold 31, already in the desired shape of the object 18, may be placed on a table 22 and advanced to the third table position 56, without the need for the first or second cutting operations at the second table position 34. It will be understood that the table 22 may move to the third table position 56 via the first moving apparatus 33 and the second moving apparatus 51, or it may move directly from the first table position 32 to the third table position 56 on a single pair of elongated rails, as described below.

In accordance with the invention, it will be understood that the molded object forming apparatus may consist of only two table positions, rather than three. When the apparatus consists of two table positions, it will be understood that the first table position will be configured to include the cutting apparatus described above, and the second table position will include the heating apparatus described above.

In a preferred embodiment, the molded synthetic material is an acrylic or other moldable plastic.

As shown in FIG. 12A, the first set of hydraulic transfer pins 24 are fired to enable the table 22 to move along the first set of elongated rails 35 between the first table position 32 and the second table position 34.

As shown in FIGS. 12B and 12C, the first set of hydraulic transfer pins 24 are fired when the table 22 has moved to the second table position 34 via the first moving apparatus 33, as described herein.

In accordance with the invention, the first set of hydraulic alignment pins 42 are fired and transfer pins 24 are retracted to enable the table 22 to move via the second moving apparatus 51 along the second pair of elongated rails 53 between the second table position 34 and the third table position 56.

As shown in FIG. 12D, the table 22 has moved to the third table position 56 via the second moving apparatus 51, as described herein.

As shown in FIG. 12E, the second set of hydraulic alignment pins 57 are configured to be fired when the table 22 has moved to the third table position 56 and is positioned to receive the synthetic material 52.

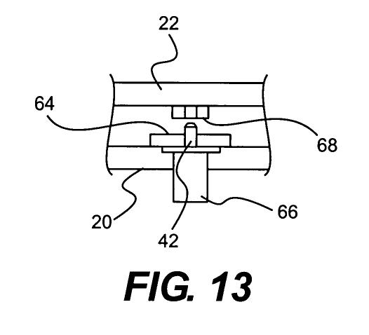

As shown in FIG. 13, an alignment pin, such as pin 42 or 57, is shown in detail. For illustration purposes, the pin in FIG. 13 is identified as a hydraulic alignment pin 42, but the pin may be the second hydraulic alignment pin 57. It is also shown that the pin includes an air cylinder mounting bracket 64, which can be positioned adjacent the support frame 20, as well as an air cylinder 66. The alignment pin 42 is configured to be received by an alignment bracket 68.

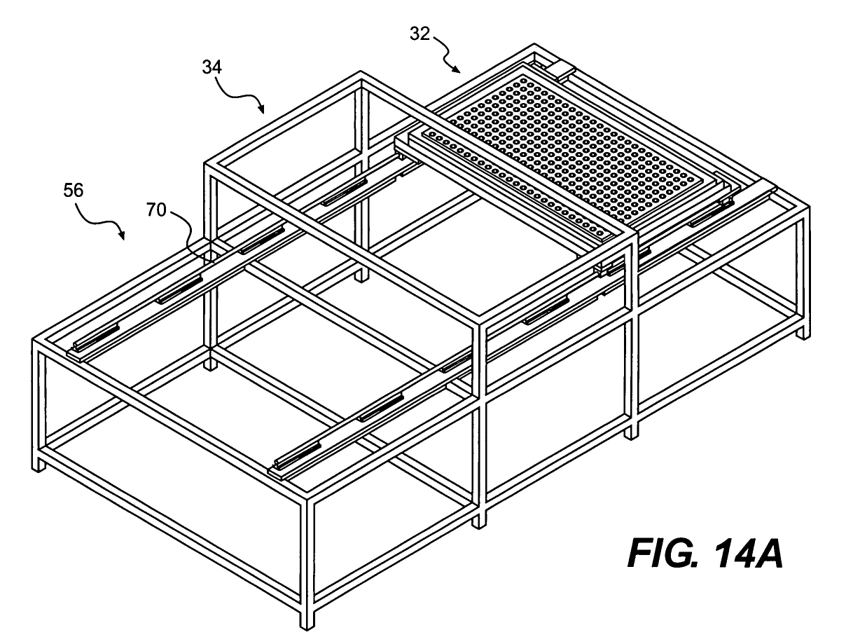

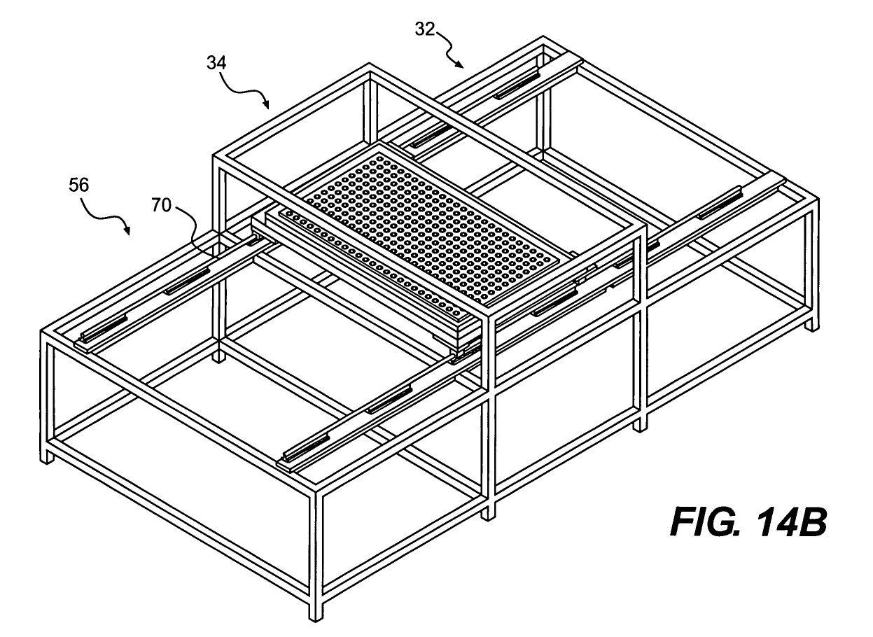

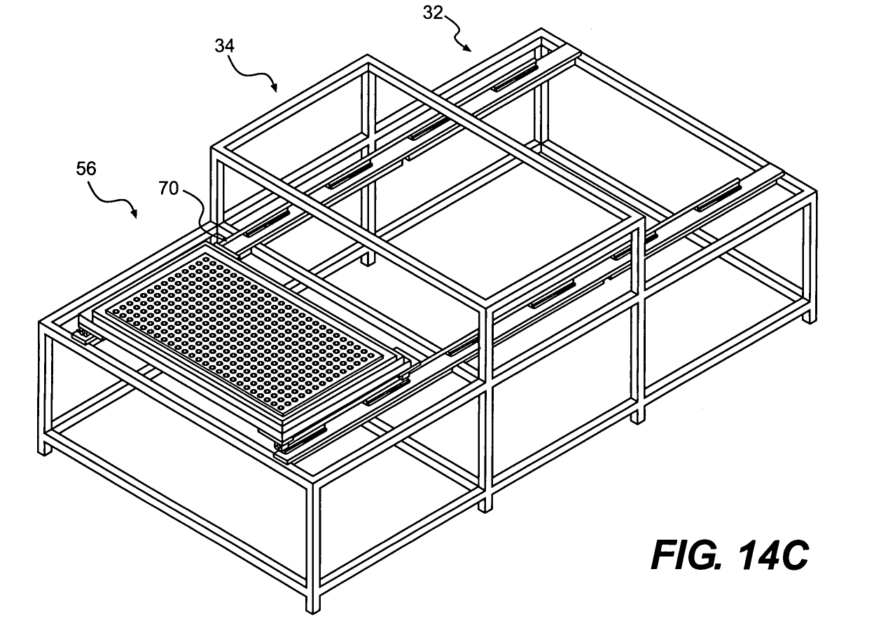

As shown in FIGS. 14A-C, and as referenced above, the table 22 may move between the first table position 32, the second table position 34, and the third table position 56, on a single pair of elongated rails 70.

As shown in FIGS. 15A-D, the cutting apparatus 40 may cut the mold material 30 in a raised position or in a lowered position. As shown in FIG. 15A, the cutting apparatus 40 may be attached to a motor 71 that assists in the raising or lowering or the cutting apparatus 40. As shown in FIGS. 15B and 15D, the motor 71 may power the movement of a drive screw 72 on the cutting apparatus in order to lower the cutting apparatus to various heights. As shown in FIG. 15C, the motor 71 may power the movement of the cutting apparatus back to a raised position. It will be understood that other well-known devices may be used to assist the movement of the cutting apparatus.

As broadly embodied in the drawings, embodiments of the invention may include methods of using the molded-object forming apparatus in the manner described above with respect to the apparatus.

In accordance with the invention, the processor 12 associated with the molded-object forming apparatus 10 may store a shape of an object 18.

In accordance with the invention, the mold material 30 is secured on the table 22 at first table position 32. In one embodiment, the first vacuum device 26 secures the mold material 30 into place on the table 22.

The first moving apparatus 33 moves the table 22 and the mold material 30 from the first table position 32 to the second position 34.

In accordance with the invention, the lifter 38 at the second table position 34 attaches to the mold material 30, and lifts it up off of the table 22, into proximity with a cutting apparatus 40. As broadly embodied herein, and referring to FIG. 4, when the table 22 reaches the first table position 34, the second set of hydraulic alignment pins 42 fires to align the table 22 in position for cutting, and for the lifter 38 to be lowered onto and engage the mold material 30, as described below.

Referring to FIG. 6, clamping frame 44, after engaging mold material 30, lifts the mold material 30 up above and out of contact with the table 22 in the direction of the cutting apparatus 40.

In accordance with the invention, and as broadly depicted in FIG. 7, when the mold material 30 is lifted by the lifting clamp 46 into the vicinity of the cutting apparatus 40, the table 22 moves back to the first table position 32.

In accordance with the invention, the cutting apparatus 40 performs a first cutting operation on the mold material 30, such as cutting an inside portion of the mold material 30. Scrap material cut off the mold material 30 during the first cutting operation falls into trash bin 50.

In accordance with the invention, the table 22 moves back into second table position 34. As broadly embodied herein, and referring to FIG. 12, when the table 22 reaches the second table position 34, the first set of hydraulic alignment pins 42 fires to align the table 22 in position for cutting. Vacuum drawn via the suction openings 29 hold the mold material on table 22 again. Lifter 38 lowers the mold material 30 down onto table 22. The cutting apparatus 40 lowers to the level of table 22 and performs a second cutting operation on the mold material 30, such as cutting an outside portion of the mold material 30, thereby defining a mold 31 having the shape of the stored object 18.

The table 22 again moves to the first table position 32. Scrap material cut off the mold material 30 during the second cutting operation falls into the trash bin 50.

In accordance with the invention, the table 22 moves back into second table position 34.

The second moving apparatus 51 moves the table 22 and the mold 30 from the second table position 34 to the third table position 56. As broadly embodied herein, and referring to FIG. 12, when the table 22 reaches the third table position 56, the second set of hydraulic alignment pins 57 fires to align the table 22 in position for plastic molding.

At the third table position 56, the heating device 54 heats the synthetic material 52.

In accordance with the invention, the second vacuum device 60 draws the synthetic material 52 onto the mold 31 on the table 22. Vacuum drawn via the suction allows the synthetic material 52 to acquire the shape of the mold 31. It should be understood that the invention may encompass a single vacuum device for all vacuum operations, or it may encompass multiple vacuum devices.

In accordance with the invention, the table 22 moves back into the second table position 34. As broadly embodied herein, and referring to FIG. 12, when the table 22 reaches the second table position 34, the first set of hydraulic alignment pins 42 fires to align the table 22 in position for cutting. The shaped synthetic material 52 is then allowed to harden. The cutting apparatus 40 lowers to the level of the table 22 and performs a third cutting operation, such as cutting an excess of synthetic material 52 that did not acquire the shape of the mold 31.

In accordance with the invention, the table 22 moves back into the first table position 32, and the hardened synthetic material 52, now in the shape of the mold 31, can be removed from the table 22.

Having thus described the invention with particular reference to the preferred embodiments thereof, it will be apparent to one of ordinary skill in the art that various changes and modifications can be made therein without departing from the spirit and scope of the present invention as defined by the appended claims.

What is claimed is:

1. A molded object forming-apparatus, comprising:
a processor storing a shape of an object;
a support frame;
a table mounted on the support frame, movable between a plurality of table positions;
a first holding device holding a mold material on said table at a first table position on the support frame;
a moving apparatus configured to move said table and the mold material from the first table position to another table position on the support frame;
a cutting apparatus positioned above the table and the mold material;
a lifter configured to raise the mold material up off of the table toward the cutting apparatus, to undergo a first cutting operation by the cutting apparatus, and lowering said mold material back onto the table to undergo a second cutting operation by a cutting apparatus, thereby defining a mold having the stored shape;
wherein the moving apparatus is configured to move said table and the mold to the other table position on the support frame;
heaters, provided at the other table position, configured to heat and soften a synthetic sheet, the softened synthetic sheet draping over the mold to define the molded object;
wherein the moving apparatus is further configured to move the table and the molded object back to the first table position,
wherein said cutting apparatus, at said first table position, is further configured to trim excess synthetic material from side surfaces of the molded object.

2. The apparatus of claim 1, wherein the shape stored in the processor is at least one of a letter or a numeral.

3. The apparatus of claim 1, wherein the molded object is a channel letter trimmed face.

4. The apparatus of claim 1, wherein the support frame defines a horizontal axis, and the moving apparatus moves the table in the horizontal axis.

5. The apparatus of claim 4, wherein the moving apparatus comprises a pair of elongated rails that provide for movement from the first table position to the other table position and from the other table position to the first table position.

6. The apparatus of claim 4, wherein the moving apparatus comprises a block, configured to hold the table, slidable on a first elongated rail.

7. The apparatus of claim 1, wherein the other table position is a second table position, and wherein the moving apparatus further comprises a first moving device configured to move said table and the mold material from the first table position to the second table position on the support frame, and a second moving device configured to move said table and the mold to a third table position on the support frame.

8. The apparatus of claim 7, wherein the moving apparatus further comprises a block, configured to hold the table, slidable on a first elongated rail.

9. The apparatus of claim 8, wherein the block further is slidable on a second elongated rail provided alongside and spaced away from the first elongated rail.

10. The apparatus of claim 9, further comprising a block shifting device for shifting the block holding the table between the first and second elongated rails.

11. The apparatus of claim 1, wherein the first holding device comprises a first vacuum pump.

12. The apparatus of claim 7, further comprising a plurality of pins at the second table position to fix the table in place at the second table position.

13. The apparatus of claim 7, further a plurality of pins at the third table position to fix the table in place at the third table position.

14. The apparatus of claim 1, further comprising a storage bin configured to receive scrap material cut off the mold material by said cutting apparatus.

15. The apparatus of claim 1, wherein the processor is supported on the support frame.

16. The apparatus of claim 1, wherein the processor is located at a remote location.

17. The apparatus of claim 1, further comprising a second holding device configured to draw the softened synthetic sheet over the mold, to form a molded object having the stored shape.

18. The apparatus of claim 17, wherein the second holding device comprises a second vacuum pump.

19. The apparatus of claim 1, wherein the cutting apparatus is in a position intermediate the first position and the other position.

20. The apparatus of claim 1, wherein the cutting apparatus is configured to perform the first cutting operation in an elevated position.

21. The apparatus of claim 1, wherein the cutting apparatus is configured to perform the first cutting operation in a lowered position.

22. A molded object forming-apparatus, comprising:
a support frame;
a table mounted on the support frame, movable between a plurality of table positions;
a first holding device holding a mold material on said table at a first table position on the support frame;
a moving apparatus configured to move said table and the mold material from the first table position to another table position on the support frame;
a cutting apparatus positioned above the table and the mold material;
a lifter configured to raise the mold material up off of the table toward the cutting apparatus, to undergo a first cutting operation by the cutting apparatus, and lowering the mold material back onto the table to undergo a second cutting operation by the cutting apparatus, thereby defining a mold having a stored shape;
wherein the moving apparatus is configured to move said table and the mold to the other table position on the support frame;
heaters, provided at the other table position, configured to heat and soften a synthetic sheet, the softened synthetic sheet draping over the mold to define the molded object.

23. The apparatus of claim 22, wherein the molded object is a channel letter trimmed face.

24. The apparatus of claim 22, wherein the support frame defines a horizontal axis, and the moving apparatus moves the table in the horizontal axis.

25. The apparatus of claim 24, wherein the moving apparatus comprises a plurality of elongated rails that provide for movement from the first table position to the other table position and from the other table position to the first table position.

26. The apparatus of claim 24, wherein the moving apparatus comprises a block, configured to hold the table, slidable on a first elongated rail.

27. The apparatus of claim 22, wherein the other table position is a second table position, and wherein the moving apparatus further comprises a first moving device configured to move said table and the mold material from the first table position to the second table position on the support frame, and a second moving device configured to move said table and the mold to a third table position on the support frame.

28. The apparatus of claim 27, wherein the first moving device comprises a block, configured to hold the table, slidable on a first elongated rail.

29. The apparatus of claim 28, wherein the second moving device comprises the block, slidable on a second elongated rail provided alongside and spaced away from the first elongated rail.

30. The apparatus of claim 29, further comprising a block shifting device for shifting the block holding the table between the first and second elongated rails.

31. The apparatus of claim 22, wherein the first holding device comprises a first vacuum pump.

32. The apparatus of claim 27, further comprising a plurality of pins at the second table position to fix the table in place at the second table position.

33. The apparatus of claim 27, further comprising a plurality of pins at the third table position to fix the table in place at the third table position.

34. The apparatus of claim 22, further comprising a storage bin configured to receive scrap material cut off the mold material by said cutting apparatus.

35. The apparatus of claim 22, wherein a processor storing a shape of an object is supported on the support frame.

36. The apparatus of claim 35, wherein the shape stored is at least one of a letter or a numeral.

37. The apparatus of claim 22, wherein a processor storing a shape of an object is located at a remote location.

38. The apparatus of claim 37 wherein the shape stored is at least one of a letter or a numeral.

39. The apparatus of claim 22, wherein the moving apparatus is further configured to move the table and the molded object back to the first table position.

40. The apparatus of claim 22, wherein said cutting apparatus, at said first table position, is further configured to trim excess synthetic material from a side surface of the molded object.

41. The apparatus of claim 22, further comprising a second holding device configured to draw the softened synthetic sheet over said mold, to form the molded object having the stored shape.

42. The apparatus of claim 41, wherein the second holding device comprises a second vacuum pump.

43. The apparatus of claim 22, wherein the cutting apparatus is in a position intermediate the first position and the other position.

44. The apparatus of claim 22, wherein the cutting apparatus is configured to perform the first cutting operation in an elevated position.

45. The apparatus of claim 22, wherein the cutting apparatus is configured to perform the first cutting operation in a lowered position.

46. A method of forming a molded object, comprising the steps of:
storing in a processor a shape of an object;
securing a mold material on a table, said table movably supported, on a support frame, at a first table position;
moving the table to a second table position on the support frame;
lifting the mold material up off the table at the second table position;
moving the table to the first table position on the support frame;
cutting a first portion of the mold material in a first cutting step;
reacquiring the mold material on the table at the second table position;
cutting a second portion of the mold material in a second cutting step, thereby defining a mold having the stored shape;
removing an excess portion of the material;
moving the table and the mold to a third table position on the table;
heating and softening a synthetic sheet at the third table position;
drawing the softened synthetic sheet onto the mold to form a molded object;
cutting the excess material from the molded object; and
removing the molded object from the mold.

47. The method of claim 46, further comprising moving the table and the molded object back to the second table position to trim excess synthetic material from sides of the molded object.

48. The method of claim 46, wherein the stored shape is a letter, the first cutting step comprises a first substep of cutting interior portions of the stored shape, and the mold material is held by lifters while the table is at the first table position.

49. The method of claim 46, wherein the second cutting step comprises cutting exterior portions of the stored shape after the mold material is reacquired by the table.

50. The method of claim 46, further comprising fixing the table to the support frame at least one of the respective first, second, and third table positions with respective first, second, and third sets of lock pins.

51. The method of claim 46, wherein the table is moved to the second table position and back to the first table position by a first table moving device.

52. The method of claim 51, wherein the table is moved from the second table position to the third table position by a second table moving device.

53. The method of claim 52, wherein a block holding the table shifts the table between the first table moving device and the second table moving device.

54. The method of claim 46, wherein the table is moved from the first table position to the second table position, and from the second table position to the third table position by a single moving device.

55. The method of claim 46, further comprising storing the mold for future use.

56. The method of claim 46, wherein cut-away mold material falls into a trash bin below the table.

57. A method of forming a molded object, comprising the steps of:
securing a mold material on a table, said table movably supported on a support frame, at a first table position;
moving the table to a second table position on the support frame;
acquiring the mold material with lifters and lifting it up off the table at the second table position;
moving the table to the first table position on the support frame;
cutting a first portion of the mold material in a first cutting step into a stored shape;
reacquiring the mold material on the table;
cutting a second portion of the mold material in a second cutting step, thereby defining a mold having the stored shape;
removing an excess portion of the material;
moving the table and the mold to a third table position on the table;
heating and softening a synthetic sheet at the third table position;
drawing the softened synthetic sheet onto the mold to form a molded object; and
removing the molded object from the mold.

58. The method of claim 57, further comprising moving the table and molded object back to the second table position to trim excess synthetic material from a side of the molded object.

59. The method of claim 57, wherein the stored shape is a letter, and the first cutting step comprises a first substep of cutting interior portions of the letter, while the mold material is held by the lifters and the table is at the first table position.

60. The method of claim 57, wherein the first cutting step comprises cutting exterior portions of the letter after the mold material is reacquired by the table.

61. The method of claim 57, further comprising fixing the table to the support frame at least one of the respective first, second, and third table positions with respective first, second, and third sets of lock pins.

62. The method of claim 57, wherein the table is moved to the second table position and back to the first table position by a first table moving device.

63. The method of claim 57, wherein the table is moved from the second table position to the third table position, by a second table moving device.

64. The method of claim 63, wherein a block holding the table shifts between the first table moving device and the second table moving device.

65. The method of claim 57, wherein the table is moved from the first table position to the second table position, and from the second table position to the third table position by a single moving device.

66. The method of claim 57, further comprising storing the mold for future use.

67. The method of claim 57, wherein cut-away mold material falls into a trash bin below the table.
